(19) United States
(12) Patent Application Publication
(10) Pub. No.: US 2014/0219065 A1
(43) Pub. Date: Aug. 7, 2014

(54) Digital Timer

(71) Applicant: James Hahn Novak, Orlando, FL (US)

(72) Inventor: James Hahn Novak, Orlando, FL (US)

(21) Appl. No.: 14/248,295

(22) Filed: Apr. 8, 2014

Related U.S. Application Data
(63) Continuation-in-part of application No. 13/923,351, filed on Jun. 20, 2013.
(60) Provisional application No. 61/662,429, filed on Jun. 21, 2012.

(51) Int. Cl. G04F 1/00

(52) U.S. Cl. CPC G04F 1/005
USPC 368/29

(57) ABSTRACT

A timer counts days or hours, instead of minutes, typically from 1 to 365 days in day mode and from 1 to 24 hours in the hour mode. An interval button can be pressed to select the number of intervals before an alarm sounds. When the start/stop button is pressed, after setting the number of intervals, the alarm will sound after the set number of intervals in the future that the start/stop button was pressed. The timer automatically repeats the last programmed interval to protect the user from forgetting to re-program for another countdown. If the user wants to program a different number of intervals, they can press a reset button and enter the number of intervals for the next event. The timer can be mounted in various manners and its housing can be designed for providing such various mounting options.

### CROSS-REFERENCE TO RELATED APPLICATION

This application is a continuation-in-part of U.S. patent application number 13/923,351, filed Jun. 20, 2013, currently pending, which claims the benefit of priority of U.S. provisional application number 61/662,429, filed Jun. 21, 2012, the contents of which are herein incorporated by reference.

### BACKGROUND OF THE INVENTION

The present invention relates to timers and, more particularly, to a digital timer that counts days instead of minutes, up to 365 days.

Many times, people require reminders every set number of days. For example, property managers and tenants often forget to change their air conditioning/furnace filters and many people are noncompliant with medication administration.

Current reminder systems include phone applications or computer programs. These systems, however, require the related device, such as a phone or computer, to operate. Many people don't have access to these devices or may be overwhelmed by the operation and programming of these devices. Many people have phone application overload and may neglect to use applications on their phone or computer.

Email reminders may be used as well. However this also requires the use of a computing device to receive the messages and/or reminders. Moreover, with large volumes of email messages received daily, such messages and/or reminders may be missed or simply ignored.

As can be seen, there is a need for an easy to use, stand-alone timer that can count periods in days instead of hours or minutes.

### SUMMARY OF THE INVENTION

In one aspect of the present invention, a timer comprises a display; a day button for adjusting a number of days before an alert is sounded; and a start/stop button for starting a countdown to the number of days set by pressing the day button, wherein the timer is programmed to countdown in only days, without an adjustment for setting hours or minutes.

In another aspect of the present invention, a method for counting down a desired number of days on a timer comprises depressing a day button to adjust the desired number of days before an alert is sounded, the number of days being shown on a display of the timer; and starting a countdown to the desired number of days set by depressing a start/stop button, wherein the timer is programmed to countdown in only days, without an adjustment for setting hours or minutes.

These and other features, aspects and advantages of the present invention will become better understood with reference to the following drawings, description and claims.

### BRIEF DESCRIPTION OF THE DRAWINGS

FIG. 1 is a front perspective view of a timer according to an exemplary embodiment of the present invention;

FIG. 2 is a back perspective view of the timer of FIG. 1;

FIG. 3 is an exploded perspective view of the timer of FIG. 1; and

FIG. 4 is a cross-sectional view taken along line 4-4 of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a timer counts days or hours, instead of minutes, typically from 1 to 365 days in day mode and from 1 to 24 hours in the hour mode. An interval button can be pressed to select the number of intervals before an alarm sounds. When the start/stop button is pressed, after setting the number of intervals, the alarm will sound after the set number of intervals in the future that the start/stop button was pressed. The timer automatically repeats the last programmed interval to protect the user from forgetting to re-program for another countdown. If the user wants to program a different number of intervals, they can press a reset button and enter the number of intervals for the next event. The timer can be mounted in various manners and its housing can be designed for providing such various mounting options.

The timer is designed to be small and portable, allowing the timer to be placed in a location related to the task to be remembered. For example, the timer can be placed in a location near medication to remind the user to take medication, or may be attached to a furnace/AC housing to remind the user to change their furnace filter.

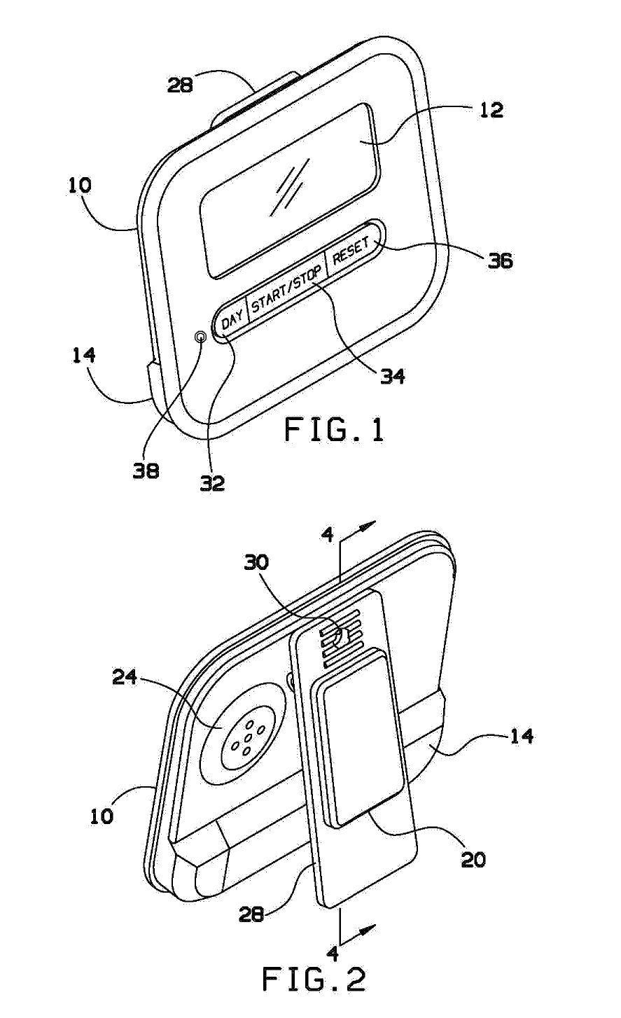

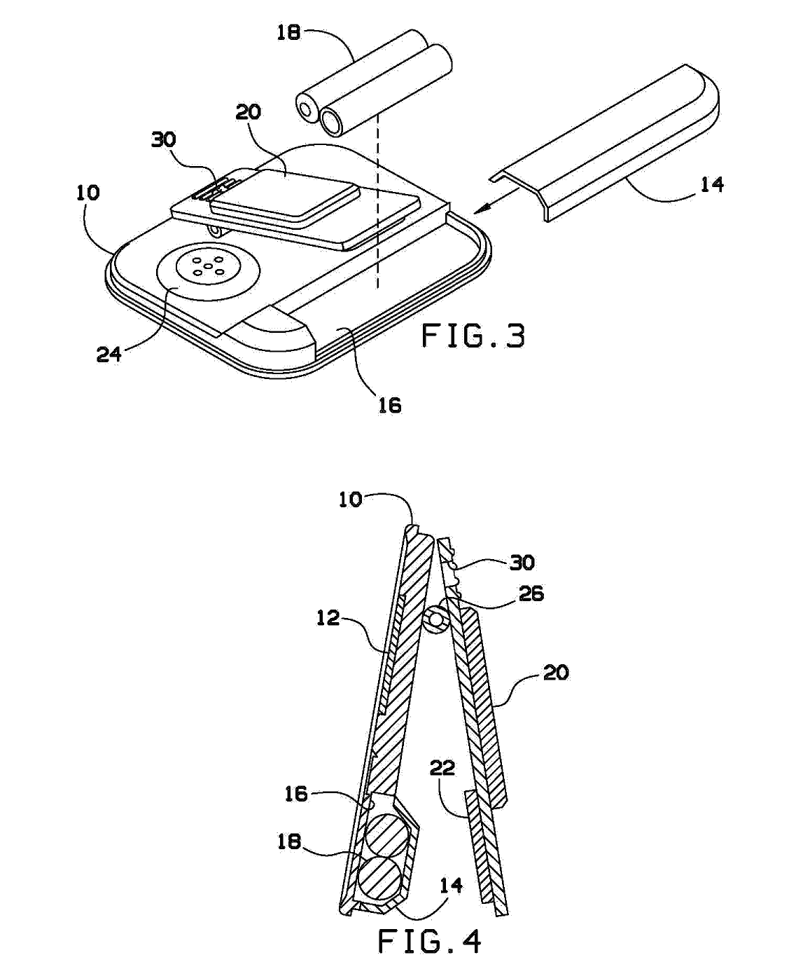

Referring now to FIGS. 1 through 4, a timer can be contained within a timer housing 10 and a display 12, such as a liquid crystal display (LCD) can be viewed from a front face of the housing 10. Control buttons, such as a day button 32, a start/stop button 34 and a reset button 36 can be accessed from the front face of the housing 10.

A speaker 24 can be designed to provide an alert. The alert can take various forms, such as a continuous beep, a periodic chirp, a siren-like alarm, or the like. The alert can sound at various times. For example, the alert can sound for a certain period of time continuously and, if not acknowledged and reset, the alert can sound periodically until reset. In some embodiments, when the alert sounds, the display 12 can show the time since the alert sounded.

The display can take various forms and can include various information. In some embodiments, the display can include a number of days, from 1 to 365, remaining until the alert. The display can include the icon “countdown” which can flash while the timer is counting down. In some embodiments, the display can include a battery icon. This icon can flash to indicate a low battery. For example, this icon can flash when the charge falls below 2.6V to signal a low battery. When the timer completes a countdown, it will sound an alarm and also, in some embodiments, an alarm icon on the display can flash.

Various methods can be included with the timer for mounting or displaying the timer. For example, a folding stand 28 can fold out about a hinge 26 to support the timer on a horizontal surface. A magnet 20 and a sticky pad 22 can be disposed behind the timer for attaching the timer to a surface, such as a furnace, a wall, a cabinet, or the like. Finally, a hail hole 30 can be provided to allow the timer to mount to a surface with a nail or screw.

The back face of the timer can include a battery compartment cover 14 that can cover a battery compartment 16 to house one or more batteries 18. Other power supplies may also be used to power the timer, such as an AC/DC transformer/plug-in power, solar power, or the like.

To use the timer of the present invention, a user can first decide what task they wish to use the timer and how many days to program. For example, if a medication needs to be taken every 30 days, the user can press the day button 32 to show “30” on the display 12. Functionality can be provided to allow a user to hold down the day button 32 to quickly advance the number of days. At the time of day that the user wishes to be reminded, they would then press the start/stop button 34. At this point, the timer will count down the number of days and sound an alert at the same time of day the start/stop button 34 was pressed, but 30 days later. When the alert sounds, the user can press the start/stop button 34 to acknowledge the alert and restart another 30 day countdown. In some embodiments, the new 30 day countdown will be exactly 30 days from the time the alarm sounded. In other embodiments, the new 30 day countdown will be 30 days from the time the alert was restarted by pressing the start/stop button. Either way, the alarm can automatically reset unless the reset button 36 is pressed. If the reset button 36 is pressed, the user can select a different number of days for the alert to be activated.

In some embodiments, referring back to FIG. 1, the timer may be configured to allow the user to set alarms throughout the day. Instead of setting the alarm for every day, every 7 days, or every 30 days, for example, the user can program the alarm to go off every 4 hours, every 6 hours, every 12 hours, or the like. In this embodiment, the day button 32 may be replaced with a button that may be labelled as an “hour” button, allowing the user to set the alarm to sound after a given number of hours. This embodiment of the present invention may be useful, for example, when taking medicines that need to be taken every so many hours.

As described above, the alarm can automatically reset to go off after the set number of hours. If the reset button is depressed, the timer settings can be reset. In some embodiments, the reset button would need to be held down a predetermined period of time in order to prevent accidental reset.

In some embodiments, a mode button 38 may be disposed on the alarm. The mode button 38 can toggle the display from displaying timer functions to displaying a clock function. In this embodiment, the buttons may have a further label, such as “hour, minute, start” for use when setting the clock.

In some embodiments, one timer can be programmed to selectively operate either as a “day” alarm or as an “hour” alarm. In other embodiments, one timer may be used only as either a “day” alarm or as an “hour” alarm. The day/hour button can be referred to generically as an “interval” button, where the interval (days or hours) is determined by either the user selection, or the programming/functioning of the timer.

A software implementation of the present invention can include the functionality of the physical device. The software digital timer may allow a user to set multiple events, such as more than 10 events, for the timer.

It should be understood, of course, that the foregoing relates to exemplary embodiments of the invention and that modifications may be made without departing from the spirit and scope of the invention as set forth in the following claims.

What is claimed is:

1. A timer comprising:
a display;
an interval button for adjusting an interval before an alert is sounded; and
a start/stop button for starting a countdown to the number of days set by pressing the day button, wherein
the timer is programmed to countdown in only hours or days, without an adjustment for setting minutes.

2. The timer of claim 1, wherein the interval button is a day button for adjusting a number of days before an alert is sounded, and the timer is programmed to countdown in only days, without an adjustment for setting hours or minutes.

3. The timer of claim 1, further comprising a reset button for resetting the interval.

4. The timer of claim 1, further comprising means for supporting the timer.

5. The timer of claim 4, wherein the means for supporting the timer includes a folding stand.

6. The timer of claim 4, wherein the means for supporting the timer includes a magnet.

7. The timer of claim 4, wherein the means for supporting the timer includes a sticky pad.

8. The timer of claim 4, wherein the means for supporting the timer includes a nail hole.

9. The timer of claim 1, further comprising a mode button to toggle between a clock display and a timer display.

10. A method for counting down a desired number of intervals on a timer, comprising:
depressing an interval button to adjust a desired number of intervals before an alert is sounded, the number of intervals being shown on a display of the timer; and
starting a countdown to the desired number of intervals set by depressing a start/stop button, wherein
the timer is programmed to countdown in only days or hours, without an adjustment for setting minutes.

11. The method of claim 10, wherein the step of depressing an interval button includes depressing a day button to adjust the desired number of days before an alert is sounded, the number of days being shown on a display of the timer, and the timer is programmed to countdown in only days, without an adjustment for setting hours or minutes.

12. The method of claim 10, further comprising resetting the desired number of intervals by depressing a reset button.

13. The method of claim 10, further comprising supporting the timer by at least one of a folding stand, a wall mount nail hole, a magnet and a sticky pad.
